(19) United States
(12) Patent Application Publication
(10) Pub. No.: US 2007/0169568 A1
(43) Pub. Date: Jul. 26, 2007

(54) Digital torque display device for wrench and method for detecting the torque

(76) Inventor: Terence Chen, Dungshan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/481,904

(22) Filed: Jul. 7, 2006

(30) Foreign Application Priority Data
Jan. 20, 2006 (TW) 095102365

(51) Int. Cl. B25B 23/14

(52) U.S. Cl. 73/862.21

(57) ABSTRACT

A wrench includes a handle and a head connected to an end of the handle. A driving member is received in a through hole in the head and a pawl is received in a first recess defined in an inner periphery of the through hole. The teeth of the pawl are engaged with the teeth of the driving member. At least one detection member is connected to the head so as to detect changes of voltage, resistance, deformation, current, phase differences, or displacement of the wrench. A display member is connected to an outside of the head and electrically connected with the at least one detection member. The user can check the digital value of the torque applied to the object. The method for detecting torque of a wrench includes steps of re-setting, operation, detection, deformation, transmitting digital signals, and displaying.

### FIELD OF THE INVENTION

The present invention relates to a digital torque display device is located on the head of the wrench and a method for detecting the torque that applied to the object.

### BACKGROUND OF THE INVENTION

A conventional wrench with a torque display device known to applicant includes a display device on the handle of the wrench and the amount of the torque is detected by the deformation of the pawl in the ratchet mechanism. This display device includes a complicated structure installed in the handle and the user has to remove the hand to check the display device. Another conventional torque display device has an audio wheel which is connected to a rear end of the handle and when the torque applied to the object reaches the pre-set amount of torque, the audio wheel generates a sound to inform the user. The user has to move slowly to avoid overly rotate the object and cannot be acknowledged the exact torque that is applied to the object. Yet another conventional wrench uses a counting device cooperated with the torque display device, wherein the user adjusts the display device when the wrench is used a pre-set times displayed by the counting device. Another conventional wrench uses an arm which is rotated to indicate the value of the torque. This type of display device cannot precisely show the value of the torque.

The present invention intends to provide a digital torque display device for a wrench and the display device is located on the head of the wrench and not covered by the user's hand during operation.

### SUMMARY OF THE INVENTION

The present invention relates to a wrench that comprises a handle and a head is connected to an end of the handle. The head has a through hole with which a driving member is received. A first recess is defined in an inner periphery of the through hole and a pawl is received in the first recess. The driving member has first teeth defined in an outer periphery thereof and the pawl has second teeth which are engaged with the first teeth of the driving member. At least one detection member is connected to the head so as to detect the torque that applied to the object. A display member is connected to an outside of the head and electrically connected with the at least one detection member.

The present invention further provides a method for detecting torque of the wrench and the method comprises the following steps:

a step of re-setting: re-setting the starting status to be “0”;

a step of operation: the wrench applying torque to an object;

a step of detection: detecting changes of voltage, resistance, deformation, current, phase differences, or displacement of the wrench;

a step of transmitting digital signals: digital signals being transmitted according to the results of the detection, and

a step of display: the display member displaying the digital value according to the digital signals received.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is an exploded view to show the wrench of the present invention;

FIG. 3 shows that the detection member is connected to the through hole of the head of the wrench;

FIG. 4 is an exploded view to show that the detection member is connected to the first recess of the head of the wrench;

FIG. 5 is a top plain view of the wrench in FIG. 4;

FIG. 6 shows that the detection member is connected to the pawl of the wrench;

FIG. 7 shows that the detection member is connected to the second recess of the wrench;

FIG. 8 shows that the detection member is connected to the second recess and located corresponding to another detection member on the pawl;

FIG. 9 is an exploded view to show that the detection member is connected to an outside of the head of the wrench, and FIG. 10 shows the steps of the method of the present invention.

### DETAILED DESCRIPTION OF THE PREFERRED EMBODIMENT

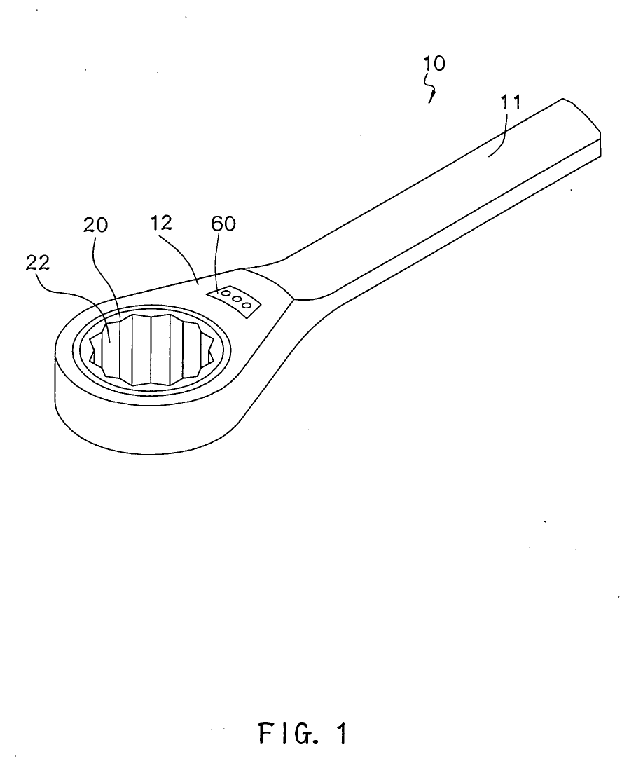

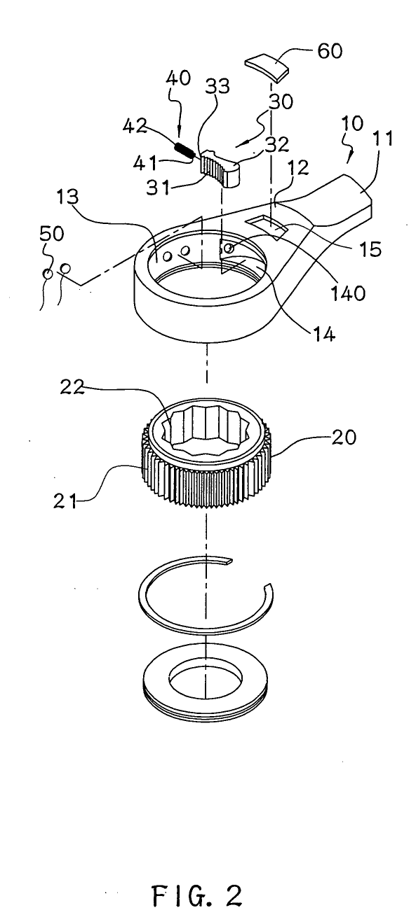

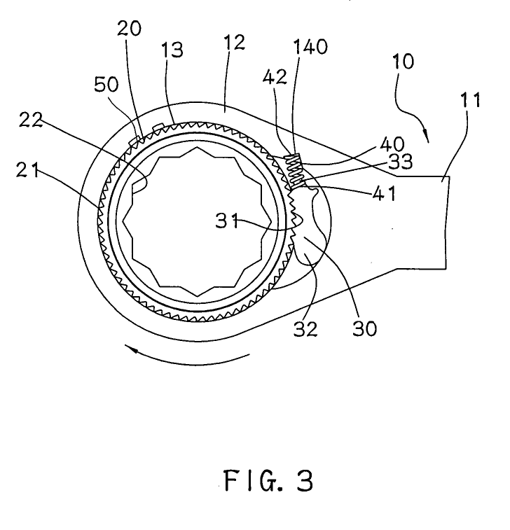

Referring to FIGS. 1 to 3, the wrench 10 of the present invention comprises a handle 11 and a head 12 is connected to an end of the handle 11. The head 12 has a through hole 13 defined therethrough and a first recess 14 is defined in an inner periphery of the through hole 13. A driving member 20 is received in the through hole 13 and has first teeth 21 defined in an outer periphery thereof. A polygonal hole 22 is defined in the driving member 20 so as to mount on an object which is not shown. A pawl 30 is received in the first recess 14 and has second teeth 31 defined in one side thereof, the second teeth 31 are engaged with the first teeth 21 of the driving member 20. A contact end 32 is defined in an end of the pawl 30 so as to be in contact with an inner periphery of the first recess 14 and a protrusion 33 extends from the other end of the pawl 30. A spring 40 has a first end 41 mounted on the protrusion 33 and a second end 42 is received in a hole 140 defined in the inner periphery of the first recess 14 so as to push the pawl 30 toward a desired direction.

Two detection members 50 are connected in the inner periphery of the through hole 13 and a display member 60 is received in a notch 15 defined in a top or an outside of the head 12. The notch 15 is closed by a transparent cover 60. The display members 50 are electrically connected with the two detection members 50. The detection members 50 detect the change of pressure that the driving member 20 applied to the inner periphery of the through hole 13, the change of deformation of the head 12 and/or the change of displacement of the driving member 20, the change is transferred into digital singles and sent to the display member 60. The display member 60 is a Liquid Crystal Display (LCD) display member and a battery or a power supply (not shown) is received in the display member 60. The display member 60 is located at the head 12 so that the user can easily check the value of the torque.

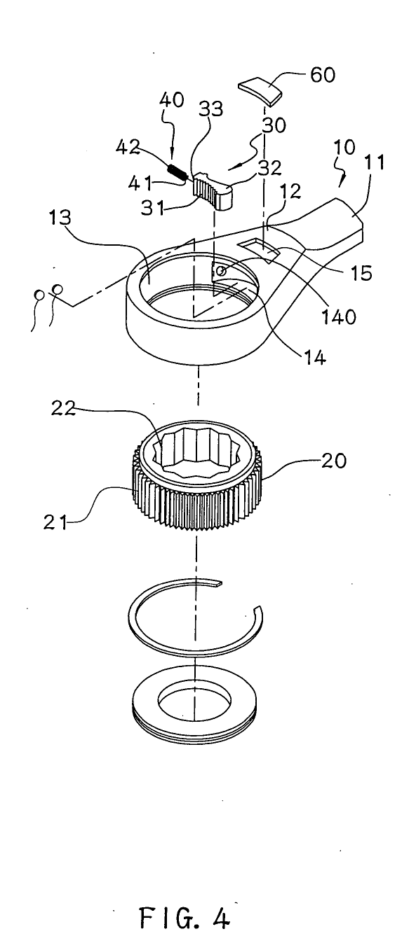

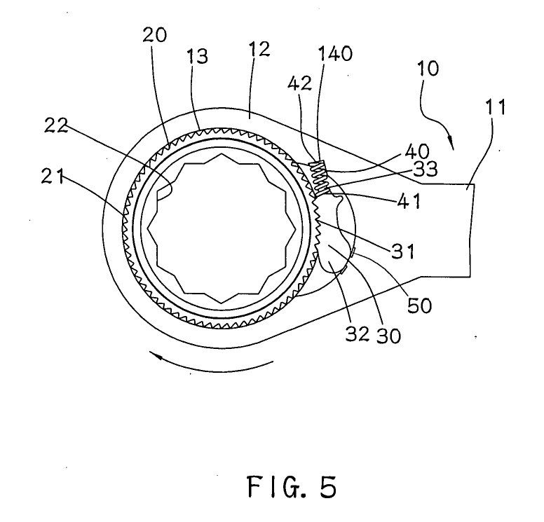

As shown in FIGS. 4 and 5, the detection members 50 can be installed in the first recess 14 so as to detect the change of displacement and/or the change of the deformation of the first recess 14 so as to be displayed in the display member 60.

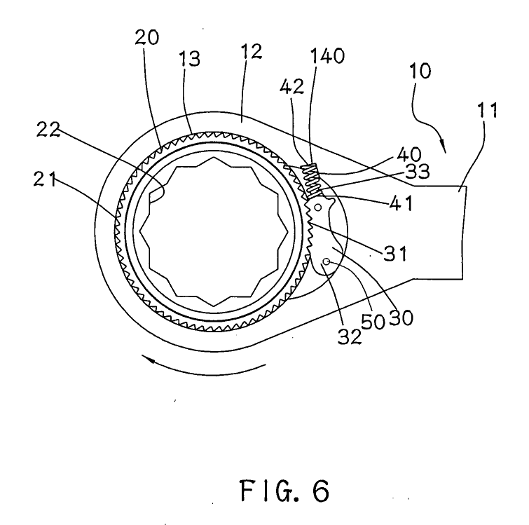

FIG. 6 shows that the detection members 50 are connected to the pawl 30 and detect the change of the deformation of the pawl 30 and/or the change of pressure of the pawl 30. The change is transferred into digital singles and sent to the display member 60.

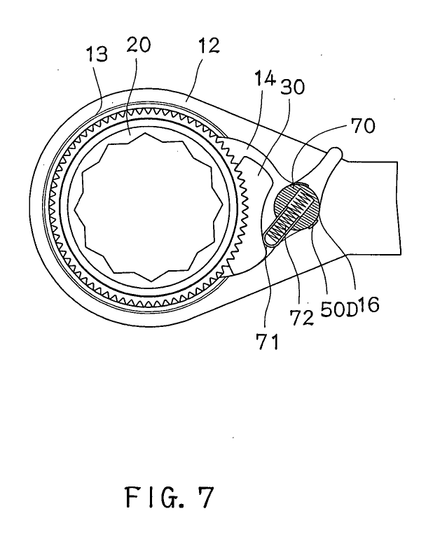

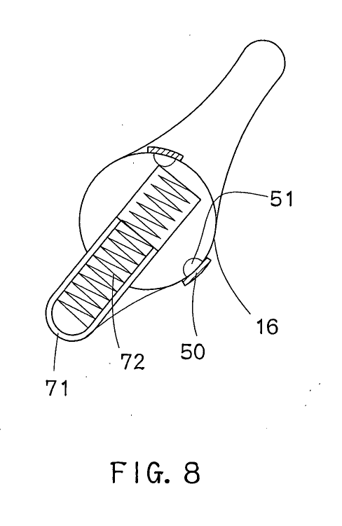

FIG. 7 shows that the wrench 10 is the same as the previous wrenches and a second recess 16 is further defined in communication with the first recess 14. A direction control member 70 is cooperated with a biasing member 71 which is biased by a spring 72, all of which are received in the second recess 16 so as to shift the effective direction of the wrench 10. A detection member 50 is connected in the second recess 16 The detection member 50 detects the displacement, phase differences or voltage differences of the direction control member 70. The change is transferred into digital singles and sent to the display member 60. As shown in FIG. 8, another detection member 51 is connected to the direction control member 70 so that the digital signals are made detecting the change of the two detection members 50, 51.

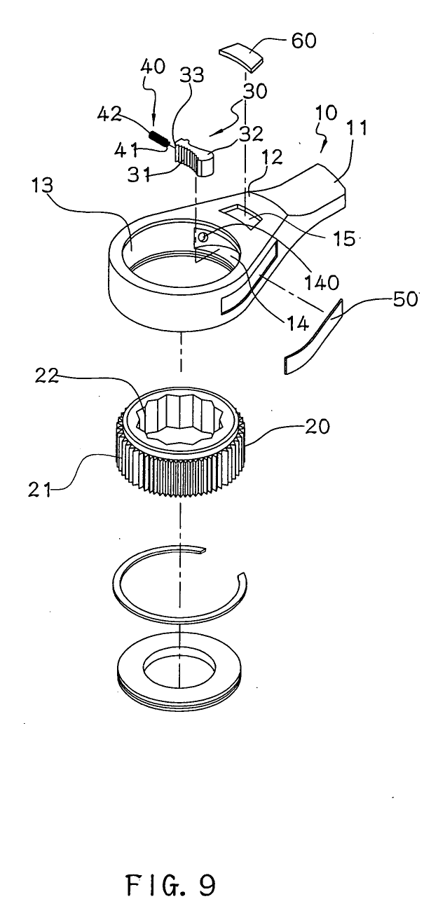

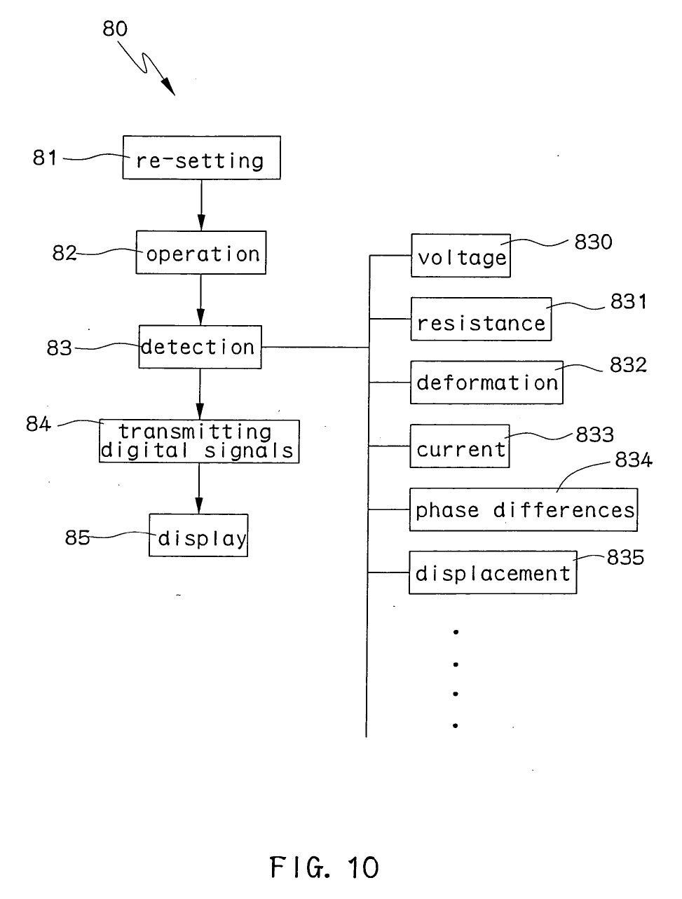

FIG. 9 shows that the head 12 has a reception recess 17 defined in the outer periphery (outside) thereof and the detection member 50 is engaged with the reception recess 17 so as to detect changes of the deformation or piezoelectric resistance of the head 12.

FIG. 10 shows a method for detecting the torque of the wrench 10 of the present invention, and the method comprises the following steps:

a step of re-setting 81: re-setting the starting status to be “0”;

a step of operation 82: the wrench applying torque to an object;

a step of detection 83: detecting changes of voltage 830, resistance 831, deformation 832, current 833, phase differences 834, or displacement 835 of the wrench;

a step of transmitting digital signals 84: digital signals being transmitted according to the results of the detection 83, and

a step of display 85: the display member 60 displaying the digital value according to the digital signals received.

The change of voltage 830 is detected by sending a weak voltage by one of the detection members 50 and the other one of the detection members 50 detects the change of the weak voltage. The change of resistance 831 is detected by detecting the change of resistance due to the change of density of parts of the wrench. The change of deformation 831 is detected by detecting the deformation of parts of the wrench 10. The change of current 833 is detected by sending a current by one of the detection members 50 and the other one of the detection members 50 detects the change of the current. The change of phase differences 834 is detected by the detection members 50 which detect the difference of phases or by the angular positions of parts of the wrench 10. The change of displacement 835 is detected by the detection members 50 which detect displacement between parts of the wrench.

The display member 60 is located on the outside of the head 12 so that when using the wrench 10, the user's hand does not cover the display member 60 up and the torque can be easily checked by viewing the digits in the display member 60. No extra adjustment processes required, the wrench 10 is easily to use and the detection members 50 are located directly to detect the different types of changes of factors so that the torque detected is accurate.

While we have shown and described the embodiment in accordance with the present invention, it should be clear to those skilled in the art that further embodiments may be made without departing from the scope of the present invention.

What is claimed is:

1. A wrench comprising:
a handle and a head connected to an end of the handle, the head having a through hole defined therethrough, a first recess defined in an inner periphery of the through hole;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
at least one detection member connected in the through hole, and
a display member connected to an outside of the head and electrically connected with the at least one detection member.

2. A wrench comprising:
a handle and a head connected to an end of the handle, the head having a through hole defined therethrough, a first recess defined in an inner periphery of the through hole;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
at least one detection member connected in the first recess, and
a display member connected to an outside of the head and electrically connected with the at least one detection member.

3. A wrench comprising:
a handle and a head connected to an end of the handle, the head having a through hole defined therethrough, a first recess defined in an inner periphery of the through hole and a second recess defined in communication with the first recess;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
a direction control member cooperated with a biasing member received in the second recess;
at least one detection member connected in the second recess, and
a display member connected to an outside of the head and electrically connected with the at least one detection member.

4. A wrench comprising:
a handle and a head connected to an end of the handle, the head having a through hole defined therethrough, a first recess defined in an inner periphery of the through hole;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
at least one detection member connected to the pawl in the first recess, and
a display member connected to an outside of the head and electrically connected with the at least one detection member.

5. A wrench comprising:
a handle and a head connected to an end of the handle, the head having a through hole defined therethrough, a first recess defined in an inner periphery of the through hole;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
at least one detection member connected to an outside of the head, and
a display member connected to an outside of the head and electrically connected with the at least one detection member.

6. The device as claimed in claim 5, wherein the head has a reception recess defined in the outside thereof and the at least one detection member is engaged with the reception recess so as to detect changes of the head.

7. A method for detecting torque of a wrench, comprising the following steps:
a step of re-setting: re-setting the starting status to be “0”;
a step of operation: the wrench applying torque to an object;
a step of detection: detecting changes of voltage, resistance, deformation, current, phase differences, or displacement of the wrench;
a step of transmitting digital signals: digital signals being transmitted according to the results of the detection, and
a step of display: the display member displaying the digital value according to the digital signals received.

8. The method as claimed in claim 7, wherein the change of voltage is detected by sending a weak voltage by one of the at least one detection member and the other one of the at least one detection member detects the change of the weak voltage.

9. The method as claimed in claim 7, wherein the change of resistance is detected by detecting the change of resistance due to the change of density of parts of the wrench.

10. The method as claimed in claim 7, wherein the change of deformation is detected by detecting the deformation of parts of the wrench.

11. The method as claimed in claim 7, wherein the change of current is detected by sending a current by one of the at least one detection member and the other one of the at least one detection member detects the change of the current.

12. The method as claimed in claim 7, wherein the change of phase differences is detected by the detection members which detect the difference of phases or by the angular positions of parts of the wrench.

13. The method as claimed in claim 7, wherein the change of displacement is detected by the detection members which detect displacement between parts of the wrench.

14. A wrench comprising:
a handle and a head connected to an end of the handle, the head having a through hole defined therethrough, a first recess defined in an inner periphery of the through hole;
a driving member received in the through hole and first teeth defined in an outer periphery of the driving member, the driving member having a polygonal hole defined through;
a pawl received in the first recess and having second teeth which are engaged with the first teeth of the driving member, a contact end defined in an end of the pawl;
at least one detection member connected to the head, and
a display member connected to an outside of the head and electrically connected with the at least one detection member.

15. The wrench as claimed in claim 14, wherein the least one detection member is connected to the through hole.

16. The wrench as claimed in claim 14, wherein the least one detection member is connected to the first recess.

17. The wrench as claimed in claim 14, wherein a second recess is defined in communication with the first recess and a direction control member cooperated with a biasing member are received in the second recess, the least one detection member is connected to the second recess.

18. The wrench as claimed in claim 14, wherein the least one detection member is connected to the pawl in the first recess.

19. The wrench as claimed in claim 14, wherein the least one detection member is connected to an outside of the head.

20. The method as claimed in claim 14, wherein the display member is a Liquid Crystal Display (LCD) display member and a battery is received in the display member, the display member is received in a notch defined in the outside of the head.
